(19) United States
(12) Patent Application Publication
(10) Pub. No.: US 2012/0050265 A1
(43) Pub. Date: Mar. 1, 2012

(54) Stereoscopic Image Display Apparatus and Stereoscopic Image Eyeglasses

(76) Inventor: Tse kai Heng, Oume-shi (JP)

(21) Appl. No.: 13/098,952

(22) Filed: May 2, 2011

(30) Foreign Application Priority Data
Aug. 24, 2010 (JP) 2010-187634

(51) Int. Cl. G06T 15/00; G02B 27/22

(52) U.S. Cl. 345/419; 359/464

(57) ABSTRACT

According to an embodiment, a stereoscopic image display apparatus includes: a measurement module configured to measure a distance from a display screen to stereoscopic image eyeglasses, and an angle of the stereoscopic image eyeglasses with respect to a normal to the display screen; and a converter configured to convert a plane image into a stereoscopic image based on the distance and the angle.

### CROSS-REFERENCE TO RELATED APPLICATION(S)

This application is based upon and claims the benefit of priority from Japanese Patent Application No. 2010-187634, filed on Aug. 24, 2010, the entire contents of which are incorporated herein by reference.

### FIELD

Embodiments described herein relate generally to a stereoscopic image display apparatus capable of displaying a stereoscopic image, and stereoscopic image eyeglasses.

### BACKGROUND

In recent years, a display for displaying stereoscopic image contents has been put to practical use. Various stereoscopic image display methods have been proposed. For example, as such methods, polarization filter eyeglasses or electronic shutter eyeglasses may be used.

For example, the polarization filter eyeglasses have a left-eye-lens and a right-eye-lens respectively provided with polarization filters having polarization directions orthogonal to each other. In a stereoscopic image display using the polarization filter eyeglasses, first, light rays respectively representing a left-eye-image and a right-eye-image are linearly polarized to have vibration directions orthogonal to each other. Next, the linearly polarized light rays are projected while being superimposed. Then, the projected light rays are split into the left-eye-image and the right-eye-image by the polarization filter eyeglasses. Thus, the left-eye-image and the right-eye-image having a parallax therebetween are simultaneously displayed in a left eye and a right eye, respectively.

For example, the electronic shutter eyeglasses have shutters each configured to open/close synchronously with images displayed in the display-device. When a right-eye-image is displayed in a display-device, a left-eye-shutter of the electronic shutter eyeglasses is closed while a right-eye-shutter is opened. Thus, only the right-eye-image can be seen. On the other hand, when a left-eye-image is displayed in the display-device, the right-eye-shutter is closed while the left-eye-shutter is opened. Thus, only the left-eye-image can be seen. Thus, the right-eye-image and the left-eye-image having a parallax therebetween are alternately displayed in left and right eyes.

In the stereoscopic image display, a display-device displays stereoscopic-dedicated images, and the user wears eyeglasses. When the user sees the stereoscopic-dedicated images on a screen without such eyeglasses, the right-eye-image and the left-eye-image overlap with each other due to a parallax therebetween, and the images on the screen cannot be viewed as a normal image.

For example, in broadcast of video programs and in distribution of video contents (video disc such as optical disc), conventional plane images (hereinafter, a conventional image differing from a stereoscopically-displayed image is referred to as a “plane image”, as compared with a “stereoscopic image”) and stereoscopic images coexist. Thus, the user needs to wear and take off stereoscopic image eyeglasses corresponding to the reproduction of a stereoscopic image and that of a plane image, respectively.

At present, there are few stereoscopic image contents yet, while there are many plane image contents. Thus, there are proposed plural conversion methods for performing arithmetic processing on a plane image to convert it into a stereoscopic image. However, sometimes, a stereoscopic image obtained from a plane image through such conversion method has less quality than contents which are originally generated as stereoscopic images.

### BRIEF DESCRIPTION OF DRAWINGS

A general architecture that implements the various features of the present invention will now be described with reference to the drawings. The drawings and the associated descriptions are provided to illustrate embodiments of the present invention and not to limit the scope of the present invention.

FIG. 1 illustrates configurations of a stereoscopic image display apparatus and stereoscopic image eyeglasses according to an embodiment.

FIG. 2 illustrates the stereoscopic image display apparatus.

FIG. 3 illustrates the stereoscopic image eyeglasses.

FIG. 4 illustrates the distance of the stereoscopic image eyeglasses to the stereoscopic image display apparatus and the angle of the stereoscopic image eyeglasses with respect to the stereoscopic image display apparatus.

FIG. 5 illustrates an example of a conversion method to convert a plane image into a stereoscopic image.

FIG. 6 illustrates another example of the conversion method to convert a plane image into a stereoscopic image.

FIG. 7 illustrates an operation procedure for transmitting wearing information from stereoscopic image eyeglasses.

FIG. 8 illustrates an operation procedure for switching between a plane image and a stereoscopic image according to a user's wearing state of the stereoscopic image eyeglasses.

### DETAILED DESCRIPTION

In general, according to one embodiment, a stereoscopic image display apparatus includes: a measurement module configured to measure a distance from a display screen to stereoscopic image eyeglasses, and an angle of the stereoscopic image eyeglasses with respect to a normal to the display screen; and a converter configured to convert a plane image into a stereoscopic image based on the distance and the angle.

It is preferable to perform conversion according to a position of a user wearing stereoscopic image eyeglasses with respect to a display screen. In addition, it is preferable to perform conversion of a plane image into a stereoscopic image according to a user's wearing state of stereoscopic image eyeglasses.

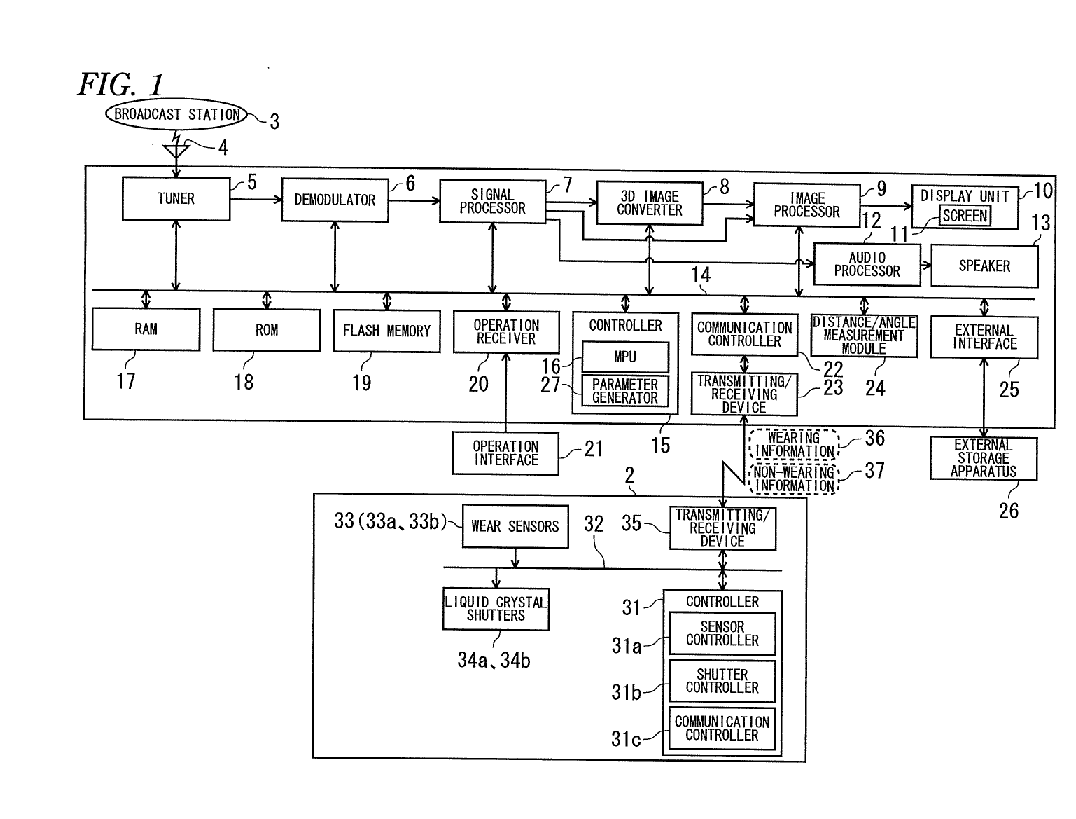

FIG. 1 illustrates configurations of a stereoscopic image display apparatus 1 and stereoscopic image eyeglasses 2 according to an embodiment. An antenna 4 is a digital terrestrial broadcast antenna or a digital satellite broadcast antenna for receiving broadcast electric waves transmitted from a broadcast station 3. A tuner 5 selects broadcast signals of a desired channel from digital terrestrial broadcast signals and digital satellite broadcast signals. The tuner 5 includes plural tuner units and can simultaneously receive plural broadcasts.

A demodulator 6 demodulates signals according to a modulation method for each digital broadcast signal. Digital terrestrial broadcast signals are demodulated by an orthogonal frequency division multiplexing (OFDM) demodulation method. Digital satellite broadcast signals are demodulated by a phase shift keying (PSK) demodulation method. Thus, the broadcast signals are demodulated into digital image and audio signals which are output to a signal processor 7.

The signal processor 7 selectively performs predetermined digital signal processing on digital image and audio signals supplied from the demodulator 6. The signal processor 7 outputs the image signals to a three-dimensional (3D) image converter 8 or an image processor 9. The signal processor 7 outputs the audio signals to an audio processor 12. The signal processor 7 has the functions of a Moving Picture Experts Group (MPEG) encoder, an MPEG decoder, and an image/audio decoder.

In a case where image signals supplied from the demodulator 6 represent plane images, and where the plane image is converted into a stereoscopic image, the signal processor 7 outputs image signals to the 3D image converter 8. If the plane image is not converted into a stereoscopic image, the signal processor 7 outputs image signals to the image processor 9. If the image signal supplied from the demodulator 6 represents a stereoscopic image, the signal processor 7 outputs the image signal to the image processor 9.

There are various methods for stereoscopically displaying an image by simultaneously or alternately displaying a right-eye-image and a left-eye-image, which have binocular parallax, on a screen to thereby enable the user to recognize the image as a stereoscopic image due to binocular parallax. For example, a Blu-ray (trademark) display employs a frame sequential method. Thus, a left-eye-image and a right-eye-image are alternately reproduced on a screen at a high speed of 120 frames (in total) per second by reproducing each of the left-eye-image and the right-eye-image at 60 frames per second. Then, with the dedicated stereoscopic eyeglasses having a left shutter and a right shutter that are alternately opened/closed synchronously with the displaying of a left-eye-image and a right-eye-image, a stereoscopic image can be seen on the screen.

For example, a digital television broadcast employs a side-by-side method. According to the side-by-side method, frames are sent to an image display apparatus by arranging a left-eye-image and a right-eye-image side by side in each frame. A single screen is divided into two parts respectively corresponding to a left-eye-image and a right-eye-image. Thus, a lateral resolution decreases by half. If an original image has a resolution of 1920×1080 dots, a left-eye-image and a right-eye-image each having a resolution of 960×1080 dots are sent to the image display apparatus which expands each of the left-eye-image and the right-eye-image and which displays the expanded left-eye-image and the expanded right-eye-image on the screen thereof. When processing image signals supplied from the demodulator 6, the signal processor 7 determines which of a plane image and a stereoscopic image the signal represents. Then, the signal processor 7 sends a determination result to a controller 15.

The 3D image converter 8 has the function of converting a plane image (two-dimensional (2D) image) into a stereoscopic image (3D image). Particularly, a plane image is converted into a left-eye-image and a right-eye-image for a stereoscopic image with binocular parallax, while estimating depth information. Among various methods for estimating the depth information, one method may be selected to be used according to the arithmetic capacity of the converter 8. The 3D image converter 8 converts a plane image transmitted from the signal processor 7 into a stereoscopic image and outputs the stereoscopic image to the image processor 9.

The image processor 9 converts the format of digital image data input from the signal processor 7 or the 3D image converter 8 into a format to be displayable on a screen 11 of the display unit 10. In addition, the image processor 9 optionally adjusts display colors. Then, the image processor outputs the converted data to the screen 11 to thereby display an image. The controller 15 changes an input source between the signal processor 7 and the 3D image converter 8. The image processor 9 has the function of converting a stereoscopic image input from the signal processor 7 into a plane image according to an instruction from the controller 15.

An audio processor 12 converts digital audio data input from the signal processor 7 into an analog audio signal to be reproducible by a speaker 13. Then, the audio processor outputs the analog audio signal to the speaker 13 and causes the speaker 13 to reproduce a sound.

All operations including the above reception operation of the stereoscopic image display apparatus 1 are collectively controlled by the controller 15. A micro processing unit (MPU) 16 is mounted on the controller 15 and controls each composing element connected thereto via a bus 14.

A random access memory (RAM) 17 is a read/write memory that stores various data necessary for data processing in the MPU 16 and operates as a buffer memory that stores image data and the like. A read-only memory (ROM) 18 is a read-only memory from which data is read, and stores a control program to be executed by the MPU 16, and the like.

A flash memory 19 is a rewritable nonvolatile semiconductor memory in which data is not lost when power is turned off. The flash memory 19 stores setting-data which concerns the display of the display unit 10 and is set by the user. The setting-data is, e.g., set values of luminance and contrast.

An operation receiver 20 receives an operation signal transmitted from an operation interface 21 and transfers the operation signal to the MPU 16. The operation interface 21 is, e.g., a remote controller utilizing wireless communication, e.g., infrared communication and Bluetooth communication, or a wired or wireless keyboard. The operation interface 21 sends operation signals. The operation receiver 20 receives the operation signals from the remote controller, the keyboard, or the like.

The communication controller 22 generates a control signal based on an instruction from the MPU 16, and sends the control signal to the stereoscopic image eyeglasses 2. The communication controller 22 sends the generated control signal to the stereoscopic image eyeglasses 2 via a transmitting/receiving device 23 such as an antenna or an infrared-emitting device. The communication controller 22 and the transmitting/receiving device 23 function as a receiving module configured to receive information transmitted from the stereoscopic image eyeglasses 2, the information representing a wearing state in which the user wears the stereoscopic image eyeglasses 2.

A distance/angle measurement module 24 measures a position of the stereoscopic image eyeglasses 2 with respect to the stereoscopic image display apparatus 1. Particularly, the distance/angle measurement module 24 measures the distance of the stereoscopic image eyeglasses 2 from the substantial center of the screen 11, and an angle of the stereoscopic image eyeglasses 2 with respect to a normal to the surface of the screen 11 at the substantial center. The distance/angle measurement module 24 performs optical scanning over an angular range of 180 degrees at the front surface side of the screen 11 to measure the distance from the substantial center of the screen 11 to a reflector of the stereoscopic image eyeglasses 2 and the angle of the reflector with respect to the normal to the screen 11. The distance is detected by measuring a time difference between a moment at which pulse-like laser light is irradiated from the distance/angle measurement module 24, and a moment at which the laser light reflected by the reflector returns thereto. The angle is detected, based on a direction from which the reflected laser-light returns thereto, among directions respectively corresponding to angles obtained by dividing the angular range of 180 degrees by a large number at the front surface side of the stereoscopic image display apparatus 1. Information representing the detected distance and the detected angle is converted into digital data. The obtained digital data is output to the controller 15 and stored in the RAM 17.

Another example of the distance/angle measurement module 24 can be such that an image of a scene in the direction of the user is taken with a camera at a central upper portion of the screen 11, that the taken image is analyzed, that the above angle is measured according to the position of the image of the stereoscopic image eyeglasses 2, and that the distance is measured according to the size of the image of the stereoscopic image eyeglasses 2. A more accurate value of the distance can be measured according to a focal length of the camera, which is determined by focusing on the stereoscopic image eyeglasses 2.

An external interface 25 is an interface such as a universal serial bus (USB) interface, an Institute of Electrical and Electronic Engineers (IEEE) 1394 interface, an external Serial ATA (AT Attachment) (eSATA) interface, a secure digital (SD) (trademark) memory card, and a high definition multimedia interface (HDMI) (trademark). An external storage device 26, such as a USB memory, a USB external device, an SD memory card and drives (such as a hard disk drive (HDD), a solid-state drive (SSD), a compact disc (CD), a digital versatile disc (DVD), and a Blu-ray (trademark) recording/reproducing device), are connected to the external interface 25.

The controller 15 has the function of a parameter generator. This function is implemented by an application-program executed by the MPU 16 of the controller 15. Usually, the application-program is stored in the ROM 18 and read and executed by the MPU 16 when used. A parameter generator 27 is an output module configured to output, based on the distance and the angle measured by the distance/angle measurement module 24, a conversion parameter used when the 3D image converter 8 converts a plane image to a stereoscopic image. A depth parameter for adjusting an optimal depth amount is output, based on the distance from the substantial center of the screen 11 to the stereoscopic image eyeglasses 2. A parallax parameter for adjusting a vector amount corresponding to the parallax caused when a subject is viewed from a left eye and a right eye is output, based on the angle of the stereoscopic image eyeglasses 2 with respect to the normal to the screen 11 at the substantial center.

The depth parameter and the parallax parameter are output by the parameter generator 27 to the 3D image converter 8. By using the parameters, the 3D image converter 8 can convert a plane image into a stereoscopic image to have an optimal effect according to a user's position.

In the stereoscopic image eyeglasses 2, a controller 31 includes a micro controller unit (MCU) serving as a built-in microprocessor, which a computer system is integrated onto a single integrated circuit. Peripheral function components, such as a ROM, a RAM, and input/output (I/O) associated parts, are mounted thereon. The controller 31 controls operations of the entire stereoscopic image eyeglasses 2. A wear sensor 33, liquid crystal shutters 34, and a transmitting/receiving device 35 are connected to the controller 31 via a data bus 32:

The controller 31 has a sensor controller 31a, a shutter controller 31b, and a communication controller 31c. These elements are implemented by application-programs executed by the MCU of the controller 31. Usually, the application-programs are stored in the ROM provided in the controller 31 and read and executed by the MCU when used.

The detector for detecting a wearing state of the user includes the sensor controller 31a and a wear sensor 33. A transmitting module includes the communication controller 31c and the transmitting/receiving device 35. The sensor controller 31a receives output signals of the wear sensor 33 mounted on the stereoscopic image eyeglasses 2, converts the received signal into a signal suited to communication, and transmits to the stereoscopic image display apparatus 1 wearing information (i.e., information indicating that the user wears the stereoscopic image eyeglasses 2) 36 or non-wearing information (i.e., information indicating that the user removes the stereoscopic image eyeglasses 2) 37 via the communication controller 31c and the transmitting/receiving device 35 implemented by an antenna or the like.

The wear sensor 33 includes a light emitter 33a and a light receptor 33b. The light emitter 33a and the light receptor 33b are provided in left and right temples, respectively, by being separated from each other so that light emitted from the light emitter 33a is received by the light receptor 33b. When the user wears the stereoscopic image eyeglasses 2, light emitted from the light emitter 33a is shielded. Thus, it is detected that the user wears the stereoscopic image eyeglasses 2.

The shutter controller 31b controls, based on shutter control signals transmitted from the stereoscopic image display apparatus 1, shutter opening/closing operations of a right-eye liquid crystal shutter 34a and a left-eye liquid crystal shutter 34b. The liquid crystal shutters 34a and 34b are configured as follows. That is, when a right-eye-image is displayed in the stereoscopic image display apparatus 1, the left-eye liquid crystal shutter 34b is closed, while the right-eye liquid crystal shutter 34a is opened. Thus, only the right-eye-image can be seen. On the other hand, when the left-eye-image is displayed therein, only the right-eye liquid crystal shutter 34a is closed, while the left-eye liquid crystal shutter 34b is opened. Thus, only the left-eye-image can be seen.

The communication controller 31c receives, via the transmitting/receiving device 35, control signals transmitted from the stereoscopic image display apparatus 1 and outputs shutter control signals to the shutter controller 31b. The communication controller 31c transmits, via the transmitting/receiving device 35, the wearing information 36 or the non-wearing information 37 to the stereoscopic image display apparatus 1.

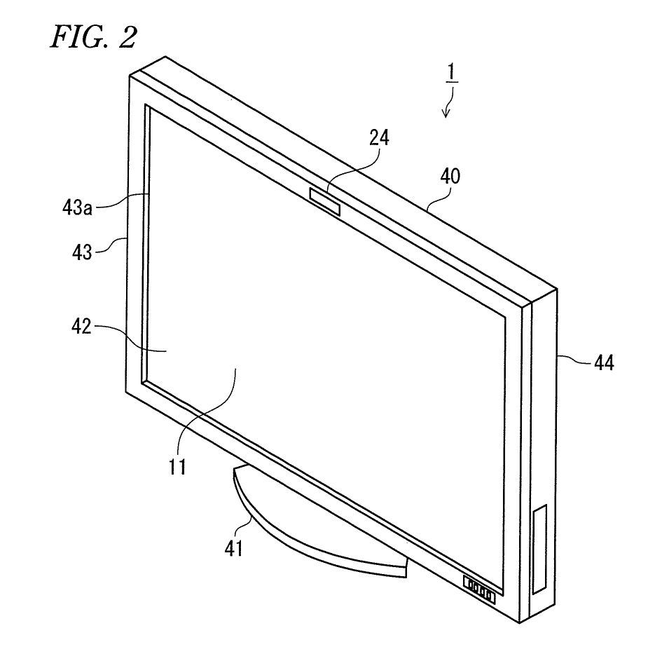

FIG. 2 illustrates the stereoscopic image display apparatus 1. The stereoscopic image display apparatus 1 includes a casing 40, and a stand 41 for supporting the casing 40. A display panel 42, such as a liquid crystal panel or a plasma display panel (PDP), is placed on the front surface side of the casing 40. A frame (not shown) for supporting the display panel 42 is arranged on the back surface side of the display panel 42. A circuit board (not shown) and a power supply circuit (not shown), which are used to drive the display panel 42, are installed in the frame.

The outer surfaces of the stereoscopic image display apparatus 1 are surrounded by a front surface cover 43 for covering the front surface side, and a part of the top surface and both side surfaces of the casing 40, and a back surface cover 44 for covering the front surface side, and a part of the top surface and both side surfaces of the casing 40. The screen 11 is a portion for displaying an image within a window portion 43a of the front cover 43 of the display panel 42. The transmitting/receiving device 20 is arranged in a front surface side part of the front surface cover 43.

The distance/angle measurement module 24 is installed in a central upper part of the front surface of the front surface cover 43. Because the distance of the stereoscopic image eyeglasses 2 from the substantial center of the screen 11 and the angle of the stereoscopic image eyeglasses 2 with respect to the normal to the surface of the screen 11 at the substantial center are measured, it is convenient to install the distance/angle measurement module 24 at an upper central part of the front surface cover 43. The distance/angle measurement module 24 can be installed at a lower central part of the front surface of the front surface cover 43.

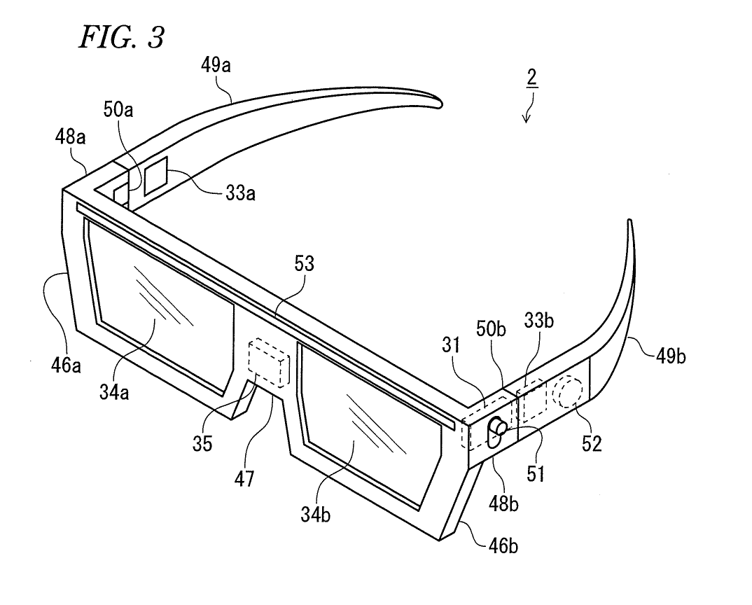

FIG. 3 illustrates the stereoscopic image eyeglasses 2. The stereoscopic image eyeglasses 2 include rims 46a, 46b, a bridge 47, armors 48a and 48b, temples 49a and 49b, and liquid crystal shutters 34a and 34b. Each of the temples 49a and 49b is turnably attached to an associated one of the armors 48a and 48b with an associated one of hinges 50a and 50b.

The transmitting/receiving device 35 for receiving control signals transmitted from the stereoscopic image display apparatus 1 is provided in the bridge 47. The controller 31 is housed in the left armor 48b. A power switch 51 is provided on the outer side of the left armor 48b. The circuits of the wear sensors 33a and 33b are provided in the left temple 49a and the right temple 49b, respectively. A battery 52 for supplying electric power to the liquid crystal shutters 34a and 34b and the wear sensor 33 is provided in a part of the temple 49b, which is close to the armor 48b.

A reflector 53 is provided at an upper part of the bridge 47. The reflector 53 is a reflection plate for reflecting light emitted from the distance/angle measurement module 24 when the distance/angle measurement module 24 measures the position of the stereoscopic image eyeglasses 2 with respect to the stereoscopic image display apparatus 1. If plural pairs of stereoscopic image eyeglasses 2 are used, one of the stereoscopic image eyeglasses 2 may be used to detect the position of the stereoscopic image eyeglasses 2. The reflector 53 may not be provided on each of the other pairs of stereoscopic image eyeglasses.

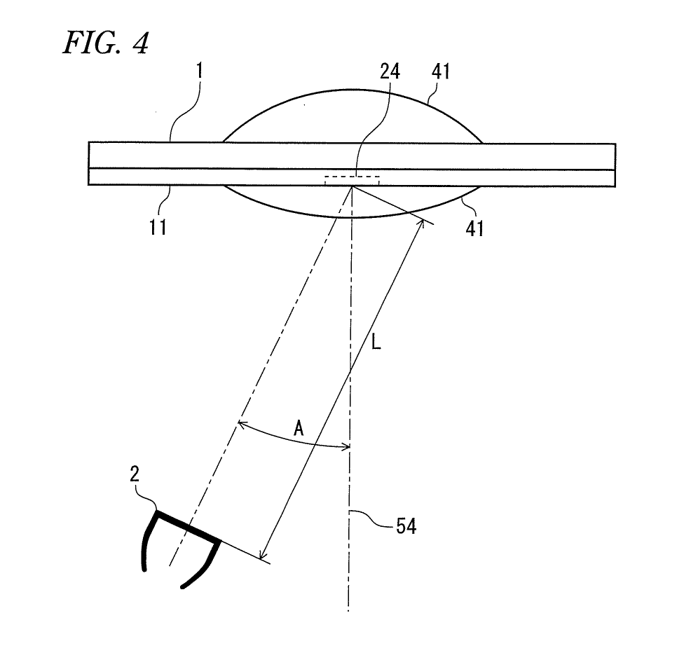

FIG. 4 illustrates the distance of the stereoscopic image eyeglasses 2 to the stereoscopic image display apparatus 1 and the angle of the stereoscopic image eyeglasses 2 with respect to the stereoscopic image display apparatus 1. FIG. 4 is a plan view of the stereoscopic image display apparatus 1, which is taken from above. A distance L is the distance between the substantial center of the screen 11 and the reflector 53 of the stereoscopic image eyeglasses 2. An angle A is an angle of the reflector 53 of the stereoscopic image eyeglasses 2 with respect to a normal 54 to the surface of the screen 11 at the substantial center. More specifically, the angle A is an angle of the projection of the stereoscopic image eyeglasses 2 onto a plane parallel to a horizontal plane with respect to the normal.

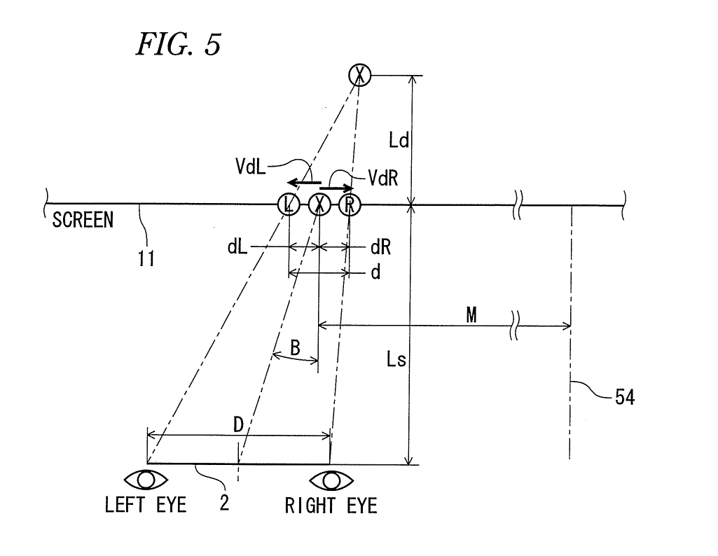

FIG. 5 illustrates an example of a conversion method to convert a plane image into a stereoscopic image. FIG. 5 illustrates an example of converting an image-pixel X of a plane image into a stereoscopic image. The 3D image converter converts the image-pixel X of the plane image while estimating depth information corresponding to the image-pixel X of the plane image. The 3D image converter 8 converts the image-pixel X of a plane image into two image-pixels, i.e., a left-eye-image-pixel and a right-eye-image-pixel for a stereoscopic image with binocular parallax. There are various methods for estimating depth information, e.g., a method for analyzing anteroposterior layers, and a method for analyzing the speed of a moving object. Such method may be selected according to the arithmetic capacity of the 3D image converter 8.

The image-pixel X is converted into a right-eye-image-pixel R and a left-eye-image-pixel L, based on depth information. An image-pixel X′ is a pixel which can be seen as that of a stereoscopic image in the direction of depth of the screen 11 after a plane image is converted into a stereoscopic image. As illustrated in FIG. 5, the image-pixel X of the plane image is seen as the image-pixel X′ located in the direction of depth of the screen 11 when a stereoscopic image is viewed.

The distance L and the angle A illustrated in FIG. 4 are measured by the distance/angle measurement module 24. As illustrated in FIG. 5, the image-pixel X is located at a position whose distance from the normal 54 to the surface of the screen 11 at the substantial center is M. A distance Ls is a distance from the stereoscopic image eyeglasses 2 to a foot of a perpendicular to the screen 11. The distance Ls is calculated by the parameter generator 27 according to the distance L and the angle A. An angle B of the stereoscopic image eyeglasses 2 with respect to a normal to the surface of the screen 11 at the image-pixel X is calculated by the parameter generator 27 according to the distance L, the angle A, and the distance M.

A depth amount Ld is calculated according to depth information corresponding to the image-pixel X and a depth parameter Pd. The depth parameter Pd for adjusting an optimal depth amount Ld is set according to the value of distance Ls. Then, the value of the depth amount Ld is adjusted. The depth parameter Pd is a predetermined parameter determined by the value of the distance Ls. The depth parameter Pd is calculated after the distance Ls is calculated, based on a predetermined formula, by the parameter generator 27. The calculated depth parameter Pd is output to the 3D image converter 8. The 3D image converter 8 calculates the depth amount Ld according to the depth information corresponding to the image-pixel X and the depth parameter Pd, and converts the plane image into a stereoscopic image to have an optimal effect according to the user's position. Alternatively, the relationship between the distance Ls and the depth parameter Pd can be stored in the ROM 18 or the flash memory 19 in the table format. In addition, after the distance Ls is calculated, the depth parameter Pd may be read from the table.

The magnitude of the parallax vector Vd corresponding to the line-segment between the right-eye-image-pixel R and the left-eye-image-pixel L is “d”. The magnitude “d” of the parallax vector Vd is calculated according to the distance D between both eyes of the user, the distance Ls, and the depth amount Ld. The distance D between both eyes of the user can be replaced with the distance between the substantial centers of the right-eye liquid crystal shutter 34a and the left-eye liquid crystal shutter 34b of the stereoscopic image eyeglasses 2. The relation among the magnitude d of the parallax vector Vd, the magnitude dR of a parallax vector VdR corresponding to the generated image-pixel R, and the magnitude dL of a parallax vector VdL corresponding to the generated image-pixel L is expressed by the following equation:

d=dR+dL

The parameter generator 27 outputs a parallax parameter Ppd for adjusting, according to an angle B, a rate of the magnitude of the parallax vector corresponding to the right-eye-image-pixel R and that of the parallax vector corresponding to the left-eye-image-pixel L. The parallax parameter Ppd is a predetermined parameter determined by the magnitude of the angle B. The parallax parameter Ppd is calculated after the angle B is calculated, based on the predetermined formula, by the parameter generator 27. The calculated parallax parameter Ppd is output to the 3D image converter 8. When calculating the magnitude dR of the parallax vector VdR and that dL of the parallax vector VdL, the 3D image converter 8 adjusts the rate between the magnitudes dR and dL, using the parallax parameter Ppd. Thus, the plane image can be converted into a stereoscopic image to have an optimal effect. Alternatively, the relationship between the angle B and the parallax parameter Ppd may be stored in the ROM 18 or the flash memory 19 in the table format. In addition, after the angle B is calculated, the parallax parameter Pp may be read from the table.

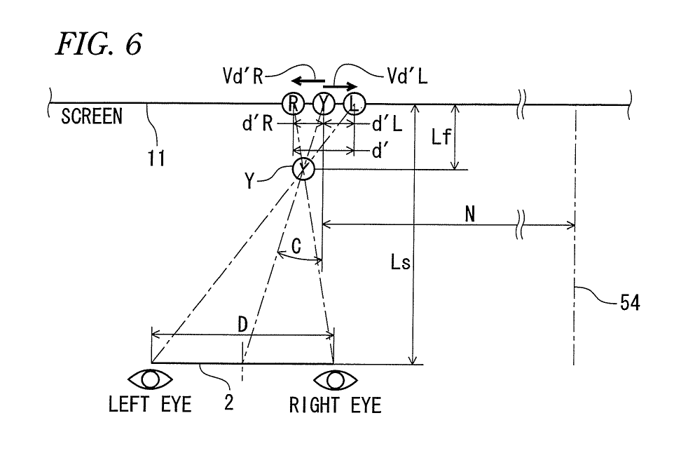

FIG. 6 illustrates another example of the conversion method to convert a plane image into a stereoscopic image. FIG. 6 illustrates an example of converting an image-pixel Y of a plane image into image-pixels of a stereoscopic image. The 3D image converter 8 converts the image-pixel Y of the plane image into a left-eye-image-pixel and a right-eye-image-pixel for a stereoscopic image with binocular parallax while estimating depth information. There are various methods for estimating depth information, e.g., a method for analyzing anteroposterior layers, and a method for analyzing the speed of a moving object. Such method may be selected according to the arithmetic capacity of the 3D image converter 8.

The image-pixel Y is converted, based on depth information, into a right-eye-image-pixel R and a left-eye-image-pixel L. An image-pixel Y′ is an image-pixel that can be seen that of a stereoscopic image in the direction of the front of the screen 11 after the plane image is converted into the stereoscopic image. As illustrated in FIG. 6, the image-pixel Y of the plane image can be seen as the image-pixel Y′ located in the direction of the front of the screen 11 when the stereoscopic image is viewed.

The distance L and the angle A illustrated in FIG. 4 are measured by the distance/angle measurement module 24. As illustrated in FIG. 6, the image-pixel Y is located at a position at a distance N from a normal 54 to the surface of the screen 11 at the substantial center. The distance Ls is a distance from the stereoscopic image eyeglasses 2 to a foot of a perpendicular to the screen 11. The distance Ls is calculated by the parameter generator 27 from the distance L and the angle A. An angle C of the stereoscopic image eyeglasses 2 with respect to the normal to the surface of the screen at the image-pixel Y is calculated by the parameter generator 27 from the distance L, the angle A, and the distance N.

A projection amount Lf in the front of the screen 11 is calculated according to depth information corresponding to the image-pixel Y and the depth parameter Pf. The depth parameter Pf is a parameter for adjusting a projection amount in the direction of the front of the screen 11. The depth parameter Pf for adjusting an optimal projection amount is set according to the value of the distance Ls. Thus, the value of the optimal projection amount Lf is adjusted. The depth parameter Pf is a predetermined parameter determined by the value of the distance Ls. The depth parameter Pf is calculated after the distance Ls is calculated, based on a predetermined formula, by the parameter generator 27. The calculated depth parameter Pf is output to the 3D image converter 8. The 3D image converter 8 calculates the projection amount Lf according to the depth information corresponding to the image-pixel Y and the depth parameter Pf. Thus, the 3D image converter 8 can convert a plane image into a stereoscopic image to have an optimal effect according to the user's position. Alternatively, the relationship between the distance Ls and the depth parameter Pf may be stored in the ROM 18 or the flash memory 19 in the table format. In addition, after the distance Ls is calculated, the depth parameter Pf may be read from the table.

The magnitude of the parallax vector Vd corresponding to the line-segment between the right-eye-image-pixel R and the left-eye-image-pixel L is “d′”. The magnitude d′ of the parallax vector is calculated from the distance D between both eyes of the user, the distance Ls, and the projection amount Lf. The relation among the magnitude d′ of the parallax vector Vd', the magnitude d′R of a parallax vector Vd'R corresponding to the generated image-pixel R, and the magnitude d′L of a parallax vector Vd'L corresponding to the generated image-pixel L is expressed by the following equation:

d′=d′R+d′L.

The parameter generator 27 outputs a parallax parameter Ppf for adjusting, according to an angle C, a rate of the magnitude of the parallax vector corresponding to the right-eye-image-pixel R and that of the parallax vector corresponding to the left-eye-image-pixel L. The parallax parameter Ppf is a predetermined parameter determined by the magnitude of the angle C. The parallax parameter Ppf is calculated after the angle C is calculated, based on the predetermined formula, by the parameter generator 27. The calculated parallax parameter Ppf is output to the 3D image converter 8. When calculating the magnitude d′R of the parallax vector Vd'R and that d′L of the parallax vector Vd'L, the 3D image converter 8 adjusts the rate between the magnitudes d′R and d′L, using the parallax parameter Ppf. Thus, the plane image can be converted into a stereoscopic image to have an optimal image. Alternatively, the relationship between the angle C and the parallax parameter Ppf may be stored in the ROM 18 or the flash memory 19 in the table format. In addition, after the angle C is calculated, the parallax parameter Ppf may be read from the table.

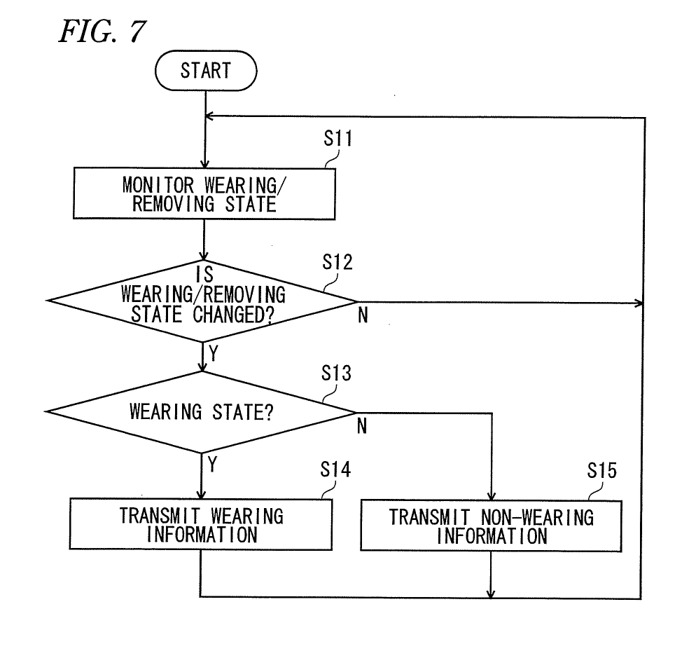

FIG. 7 illustrates an operation procedure for transmitting wearing information from the stereoscopic image eyeglasses 2. In step S11, the sensor controller 31a of the controller 31 monitors change of an output signal of the wear sensor 33. Thus, the sensor controller 31a monitors whether the user wears or removes the stereoscopic image eyeglasses 2. When the user turns on the power switch 51 of the stereoscopic image eyeglasses 2, the sensor controller 31a starts monitoring an output signal of the wear sensor 33.

In step S12, the sensor controller 31a determines whether a wearing/removing state of the user changes. If the wearing/removing state changes, the procedure proceeds to step S13. If the wearing/removing state doesn't change, the procedure returns to step S11 in which the sensor controller 31a continues to monitor. In step S13, the sensor controller 31a determines whether the user is brought into the wearing state. If the user wears the stereoscopic image eyeglasses 2, the procedure proceeds to step S14. If the user removes the stereoscopic image eyeglasses 2, the procedure proceeds to step S15.

In step S14, the communication controller 31c transmits the wearing information 36 to the stereoscopic image display apparatus 1 via the transmitting/receiving device 35. Then, the stereoscopic image eyeglasses 2 are again brought into a mode in which the wearing/removing state is monitored. In step S15, the communication controller 31c transmits the non-wearing information 37 to the stereoscopic image display apparatus 1 via the transmitting/receiving device 35. Then, the stereoscopic image eyeglasses 2 are again brought into a mode in which the wearing/removing state is monitored. When the user turns off the power switch 51 of the stereoscopic image eyeglasses 2, a sequence of operations is finished.

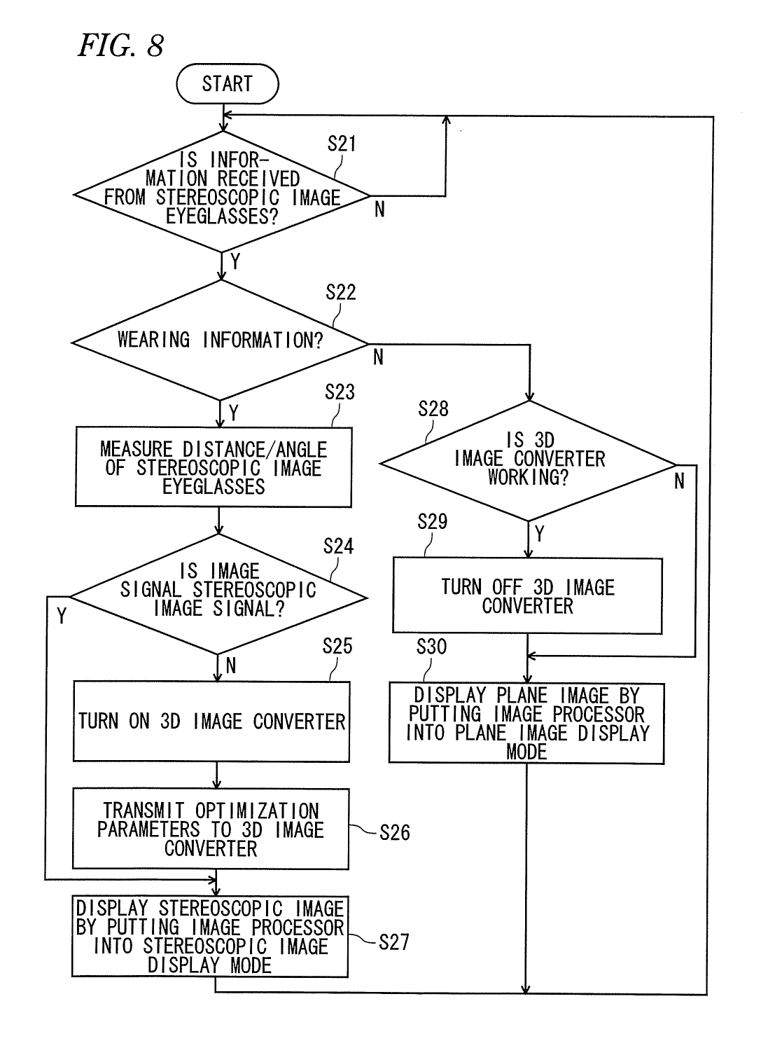

FIG. 8 illustrates an operation procedure for switching between a plane image and a stereoscopic image according to the user's wearing state of the stereoscopic image eyeglasses 2. When the user wears the stereoscopic image eyeglasses 2, a stereoscopic image is displayed. When the user removes the stereoscopic image eyeglasses 2, a displayed image is changed to a plane image. Accordingly, when the user wears the stereoscopic image eyeglasses 2, the stereoscopic image display apparatus 1 converts, if an original image signal represents a plane image, the plane image into a stereoscopic image. If the original image signal represents a stereoscopic image, the stereoscopic image display apparatus 1 displays the stereoscopic image on the screen 11 as it is. When the user removes the stereoscopic image eyeglasses 2, the stereoscopic image display apparatus 1 displays, if the original image signal represents a plane image, the plane image as it is. If the original image signal represents a stereoscopic image, the stereoscopic image display apparatus 1 converts the stereoscopic image into a plane image and displays the plane image on the screen 11.

In step S21, the controller 15 of the stereoscopic image display apparatus 1 determines whether the controller 15 receives the wearing information 36 or the non-wearing information 37. The controller 15 can make such determination by receiving such information from the communication controller 22. If the controller 15 receives such information, the procedure proceeds to step S22.

In step S22, the controller 15 determines whether the received information is the wearing information 36 or the non-wearing information 37. If the received information is the wearing information 36, the procedure proceeds to step S23. If the received information is the non-wearing information 37, the procedure proceeds to step S28.

In step S23, the controller 15 causes the distance/angle measurement module 24 to measure the distance and the angle of the stereoscopic image eyeglasses 2. The distance/angle measurement module 24 measures the distance of the stereoscopic image eyeglasses 2 from the substantial center of the screen 11 and the angle of the stereoscopic image eyeglasses 2 with respect to the normal to the surface of the screen 11 at the substantial center. Information representing the detected distance and the detected angle is output to the controller 15 and stored in the RAM 17.

The measurement of the distance and angle of the stereoscopic image eyeglasses 2 is performed not only after the stereoscopic image eyeglasses 2 transmits the wearing information 36 to the stereoscopic image display apparatus 1 but at another timing. For example, the distance and the angle of the stereoscopic image eyeglasses 2 may be measured at predetermined time intervals. This is because the user can moves among viewing-positions while the user wears the stereoscopic image eyeglasses 2. Even in this case, conversion according to the user's position can be performed by measuring the position of the stereoscopic image eyeglasses at predetermined time intervals. The position of the stereoscopic image eyeglasses 2 can be measured regardless of whether the user wears the stereoscopic image eyeglasses 2.

In step S24, the controller 15 determines whether an image represented by an image signal output from the signal processor 7 is a plane image or a stereoscopic image. If the image represented by the output image signal is a stereoscopic image, the procedure proceeds to step S27. If the image represented by the output image signal is a plane image, the procedure proceeds to step S25.

In step S25, the controller 15 activates the 3D image converter 8. In addition, the controller 15 inputs a signal representing a plane image, which is output from the signal processor 7, to the 3D image converter 8. In step S26, the parameter generator 27 generates, based on the distance L and the angle A measured by the distance/angle measurement module 24, the depth parameter and the parallax parameter used when the 3D image converter 8 converts a plane image to a stereoscopic image. The controller 15 outputs to the 3D image converter 8 the depth parameter and the parallax parameter output by the parameter generator 27. By using the parameters, the 3D image converter 8 can convert a plane image into a stereoscopic image to have an optimal effect according to the user's position.

In step S27, the controller 15 puts the image processor 9 into a mode in which the stereoscopic image display apparatus 1 displays a stereoscopic image, so that a stereoscopic image is displayed on the screen 11. If an original image signal output from the signal processor 7 represents a stereoscopic image, the image processor 9 displays the stereoscopic image as it is. That is, a stereoscopic image output from the 3D image converter 8 is displayed as a stereoscopic image.

In step S28, the controller 15 determines whether the 3D image converter 8 is operating. If the 3D image converter 8 is operating, the procedure proceeds to step S29 in which an operation of the 3D image converter 8 is stopped. If the 3D image converter 8 is not operating, the procedure proceeds to step S30.

In step S30, the controller 15 puts the image processor 9 into a mode in which a plane image is displayed. If an original image signal output from the signal processor 7 represents a plane image, the image processor 9 displays the plane image as a plane image. If an original image signal output from the signal processor 7 represents a stereoscopic image, the image processor 9 changes the stereoscopic image to a plane image and displays the plane image as it is. If the original image is, e.g., a stereoscopic image for stereoscopically displaying an image according to the side-by-side method, the stereoscopic image can be converted into a plane image by expanding only one of a right-eye-image and a left-eye-image to the size of the display screen and displaying the stereoscopic image.

As described above, the procedure for switching therebetween begins at a time at which the user wears or removes the stereoscopic image eyeglasses 2. When the user wears the stereoscopic image eyeglasses 2, the stereoscopic image display apparatus 1 converts, if an original image signal represents a plane image, the plane image into a stereoscopic image. If the original image signal represents a stereoscopic image, the stereoscopic image is displayed on the screen as it is. When the user removes the stereoscopic image eyeglasses 2, the stereoscopic image display apparatus 1 displays, if the original image signal represents a plane image, the plane image as it is. If the original image signal represents a stereoscopic image, the stereoscopic image display apparatus 1 converts the stereoscopic image into a plane image and displays the plane image on the screen. In the conversion from a plane image to a stereoscopic image at the 3D image converter 8, the distance and the angle of the stereoscopic image eyeglasses 2 with respect to the stereoscopic image display apparatus 1 are measured. Depth parameters Pd and Pf, and the parallax parameters Ppd and Pdf are output from measurement data by the parameter generator 27. According to such parameters, the values of the depth amount Ld, the projection amount Lf, the magnitudes of the parallax vectors VdR, Vd'R at the generation of an image-pixel R, and the magnitudes of the parallax vectors VdL and Vd'L at the generation of the image-pixel L are adjusted. Thus, the 3D image converter 8 can convert a plane image into a stereoscopic image to have an optimal effect.

Thus, when the user wears the stereoscopic image eyeglasses, a plane image can automatically be converted into a stereoscopic image. Further, a plane image can be converted into a stereoscopic image to have an optimal effect according to the user's position.

The invention is not limited to the above embodiment, and can be embodied by changing the components thereof without departing the scope of the invention. For example, plural components of above embodiment may be appropriately combined, and several components may be deleted from all the components.

1. A stereoscopic image display apparatus, comprising:
a measurement module configured to measure a distance from a display screen to stereoscopic image eyeglasses, and an angle of the stereoscopic image eyeglasses with respect to a normal to the display screen; and
a converter configured to convert a plane image into a stereoscopic image based on the distance and the angle.

2. The apparatus of claim 1, further comprising:
a receiving module configured to receive, from the stereoscopic image eyeglasses, wearing state information representing that a user wears the stereoscopic image eyeglasses,
wherein the measurement module measures, after receiving the wearing state information, the distance and the angle.

3. The apparatus of claim 1,
wherein the measurement module measures the distance of the stereoscopic image eyeglasses from a substantial center of the display screen and the angle of the stereoscopic image eyeglasses with respect to the normal to the display screen at the substantial center thereof.

4. The apparatus of claim 1, further comprising:
a front surface cover,
wherein the measurement module is on a front surface cover at a central upper portion or a central lower portion thereof.

5. The apparatus of claim 1, further comprising:
a parameter generator configured to generate a parameter based on the distance and the angle,
wherein the converter converts the plane image into the stereoscopic image based on the parameter.

6. The apparatus of claim 5,
wherein the parameter generator generates a depth parameter and a parallax parameter.

7. The apparatus of claim 6,
wherein the depth parameter is determined by a value of a distance from the stereoscopic image eyeglasses to a foot of a normal to the display screen.

8. The apparatus of claim 6,
wherein the parallax parameter is determined by a magnitude of the angle of the stereoscopic image eyeglasses with respect to the normal to the surface of the display screen.

9. Stereoscopic image eyeglasses, comprising:
a detector configured to detect a wearing state of the user upon blocking of a light traveling from a light emitter to a light receptor; and
a transmission module configured to transmit, to a stereoscopic image display apparatus, a wearing state information representing that the user wares the stereoscopic image eyeglasses.
